(19) United States
(12) Patent Application Publication
(10) Pub. No.: US 2011/0270891 A1
(43) Pub. Date: Nov. 3, 2011

(54) PAPERLESS PURCHASE DATA AGGREGATION SYSTEM

(76) Inventor: Ofer HAIMOVICH, Tel-Aviv (IL)

(21) Appl. No.: 12/772,636

(22) Filed: May 3, 2010

(51) Int. Cl. G06F 17/30

(52) U.S. Cl. 707/802; 707/E17.005; 707/E17.044

(57) ABSTRACT

A data processing system for aggregating user related purchase data such as invoices. One system comprises identification devices, each associated with a user and comprising user identification data; and a server connected to a communication link. The server comprises a data structure arranged to receive the user identification data and the user related purchase data; and an application. The server is configured to receive the user related purchase data in association with the user identification data from the identification device presented to a vendor. The vendor generates the user related purchase data in relation to user purchase. The user related purchase data is aggregated on the server in association with the user identification data, and the server is configured to allow the user to aggregate purchase data in a paperless manner.

### BACKGROUND

1. Technical Field

The present invention relates to the field of merchandising, and more particularly, to electronic commerce.

2. Discussion of Related Art

Environmental awareness and the complexity of modern life based on consumption both require electronic processing of purchase data. However, most debits, especially for everyday transactions are printed on paper by the vendors.

### BRIEF SUMMARY

Embodiments of the present invention provide a data processing system for aggregating user related purchase data such as invoices. One data processing system comprises a plurality of identification devices, each associated with a user and comprising user identification data; and a server connected to a communication link. The server comprises a data structure arranged to receive the user identification data and the user related purchase data; a graphical user interface arranged to allow access to the database; and an application arranged to manage the data structure, the graphical user interface and communication via the communication link. The server is configured to receive the user related purchase data in association with the user identification data from a vendor, the vendor receiving the user identification data from the identification device and generating the user related purchase data in relation to user purchase. The user related purchase data is aggregated on the server in association with the user identification data, and the server is configured to allow the user to aggregate purchase data in a paperless manner.

Embodiments of the present invention provide a computer implemented method of aggregating purchase data comprising: configuring an identification device associated with a user to comprise user identification data; receiving the user identification data from the identification device during a purchase event of the user from a vendor; generating purchase data in relation to the purchase event; storing the purchase data on a server in association with the user identification data; and allowing the user to access the stored purchase data via a communication link. The purchase data is aggregated on the server in association with the user identification data, and the server is configured to allow the user to aggregate purchase data in a paperless manner.

Accordingly, according to an aspect of the present invention, there is provided a method, wherein users or vendors are further allowed to determine a paperless or a paper receipt mode of the user purchase data.

Accordingly, according to an aspect of the present invention, there is provided a method, comprising enhanced and detailed analyzing of the purchase data.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a high level schematic block diagram of a data processing system for aggregating user related purchase data, according to some embodiments of the invention; and

FIG. 2 is a high level schematic flowchart illustrating computer implemented method of aggregating purchase data, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

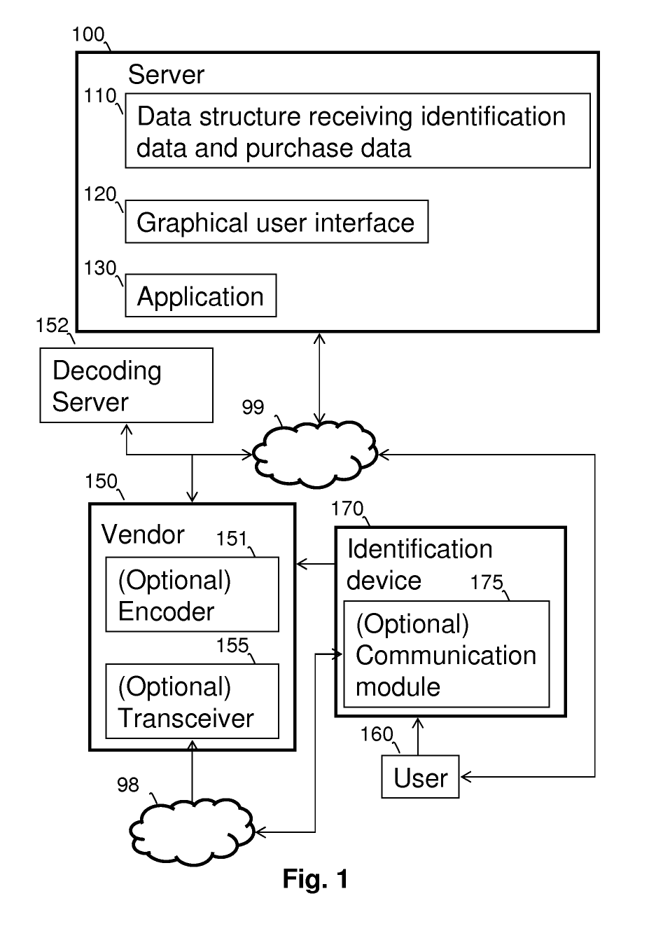

FIG. 1 is a high level schematic block diagram of a data processing system for aggregating user related purchase data, according to some embodiments of the invention. The data processing system comprises identification devices 170, each associated with a user 160 and comprising user identification data; and a server 100 connected to a communication link 99. Server 100 comprises a data structure 110 arranged to receive the user identification data and the user related purchase data; a graphical user interface 120 arranged to allow access to database 110; and an application 130 arranged to manage database 110, graphical user interface 120 and communication via communication link 99.

According to some embodiments of the invention, when user 160 wants to purchase by vendor 150, user 160 presents identification device 170 to vendor 150 (e.g., a cashier), and upon identification, purchase data is sent via communication link 99 to server 100 to be stored in data structure 110. Server 100 is configured to receive the user related purchase data in association with the user identification data from a vendor 150. Vendor 150 receives the user identification data from identification device 170 and generates the user related purchase data in relation to user purchase. Data structure 110 may be created during the operation of the system or comprise a predefined database, e.g., with identification data of members.

According to some embodiments of the invention, the user related purchase data is aggregated on server 100 in association with the user identification data, and server 100 is configured to allow user 160 to aggregate purchase data in a paperless manner Moreover, the user related purchase data may be aggregated on server 100 in a detailed manner, such as allowing access to each purchased article or service, and allowing use thereof.

According to some embodiments of the invention, application 130 may be arranged to analyze the user related purchase data and allow various ways of processing them, such as aggregation according to various criteria, and various comparisons (e.g., according to article type, price and vendor 150). Furthermore, application 130 may allow presenting the analyzed data on graphical user interface 120 and allow users to further manipulate the detailed data.

According to some embodiments of the invention, user 160 and/or vendor 150 may decide during each purchase, whether to print the user related purchase data or to save the data in a paperless manner on server 100. User 160 or vendor 150 may predefine a default working mode in relation to these options.

According to some embodiments of the invention, vendor 150 may further comprise an encoder 151 arranged to encode the purchase data before sending it to server 100. The encoded purchase data may be sent to a decoding server 152, associated with either vendor 150 or server 100, each of which may have specified access limitation thereto. Decoding server 152 may be arranged to decode the encoded purchase data.

According to some embodiments of the invention, the identification data may be represented on identification device 170 as a barcode encoding both the identification data and card identification, allowing vendor 150 to identify the use of identification device 170.

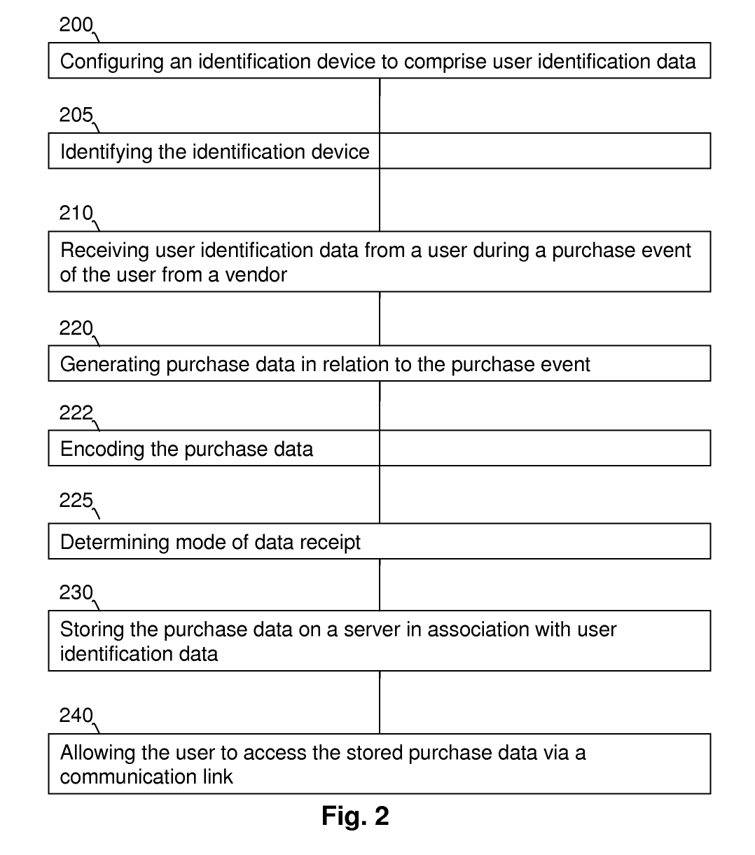

FIG. 2 is a high level schematic flowchart illustrating computer implemented method of aggregating purchase data, according to some embodiments of the invention. The computer implemented method comprises: configuring an identification device associated with a user to comprise user identification data (stage 200); receiving the user identification data from the identification device during a purchase event of the user from a vendor (stage 210); generating purchase data in relation to the purchase event (stage 220); storing the purchase data on a server in association with the user identification data (stage 230); and allowing the user to access the stored purchase data via a communication link (stage 240). The purchase data is aggregated on the server in association with the user identification data, and the server is configured to allow the user to aggregate purchase data in a paperless manner.

According to some embodiments of the invention, the computer implemented method may comprise: Identifying the identification device (stage 205) and encoding the purchase data (stage 202).

Some embodiments of the invention comprise a computer program product for aggregating purchase data, the computer program product comprising a computer usable medium having computer usable program code tangibly embodied thereon. The computer usable program code comprises: computer usable program code for receiving user identification data from an identification device during a purchase event of a user from a vendor, wherein the identification device is associated with the user and is configured to comprise the user identification data; computer usable program code for generating purchase data in relation to the purchase event; computer usable program code for storing the purchase data on a server in association with the user identification data; and computer usable program code for allowing the user to access the stored purchase data via a communication link. The purchase data is aggregated on the server in association with the user identification data, and the server is configured to allow the user to aggregate purchase data in a paperless manner.

According to some embodiments of the invention, the computer usable program code further comprises computer usable program code for allowing the user to determine the mode of data receipt, computer usable program code for allowing users to directly refer to details of their purchase data or computer usable program code for analyzing the purchase data.

According to some embodiments of the invention, identification device 170 may comprise a communication module 175 and vendor 150 comprises a transceiver 155. Communication module 175 may be arranged to allow sending the user identification data to transceiver 155 via a wireless communication link 98. Communication module 175 may allow sending the user identification data to transceiver 155 by vendor 150 in a wireless manner, such as over radio frequency (RF) communication, cellular communication or any other wireless method of communication. Transceiver 155 may be integrated for example in a register connected to communication link 99 and arranged to send server 100 the user identification data and the purchase data upon completion of the transaction via communication link 99.

According to some embodiments of the invention, user identification data may comprise various information such as user number at server 100, payment data (e.g., credit card number), membership in customer clubs, coupons and the like.

According to some embodiments of the invention, graphical user interface 120 may comprise various possibilities to act on aggregated purchase data such as analyzing the data, sharing the data, controlling consumption behavior, preparing tax reports and discussing products over the internet.

According to some embodiments of the invention, communication link 99 may comprise internet, wireless communication, cellular communication and so forth.

According to some embodiments of the invention, user purchase data may comprise invoices, debits, coupons, shopping lists relating to material or virtual transactions.

According to some embodiments of the invention, the method may further comprise analyzing the user related purchase data and allow various ways of processing them, such as aggregation according to various criteria, and various comparisons (e.g., according to article type, price and vendor). Furthermore, the method may allow presenting the analyzed data on such that users may further manipulate the detailed data.

According to some embodiments of the invention, storing the purchase data on a server in association with the user identification data (stage 230) may comprise relating the purchase data to data in a predefined database comprising identification data.

According to some embodiments of the invention, the method may further comprise allowing users to directly refer to details of their purchase data such as individual articles or services, their prices, the purchase date and place and so forth. The method may further comprise analyzing the data according to predefined criteria, to various aggregation schemes or according to user defined queries.

According to some embodiments of the invention, the method may further comprise determining mode of data receipt (stage 225) as either paper, paperless or a combination thereof. The user and/or the vendor may decide during each purchase, whether to print the user related purchase data or to save the data in a paperless manner. The user or the vendor may predefine a default working mode in relation to these options.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A data processing system for aggregating user related purchase data comprising:
a plurality of identification devices, each associated with a user and comprising user identification data; and
a server connected to a communication link, the server comprising:
a database comprising the user identification data and the user related purchase data;
a graphical user interface arranged to allow access to the database; and
an application arranged to manage the database, the graphical user interface and communication via the communication link,
wherein the server is configured to receive the user related purchase data in association with the user identification data from a vendor, the vendor receiving the user identification data from the identification device and generating the user related purchase data in relation to user purchase, and
wherein the user related purchase data is aggregated on the server in association with the user identification data, and the server is configured to allow the user to aggregate purchase data in a paperless manner.

2. The data processing system of claim 1, wherein the application is arranged to analyze the user related purchase data and allow various ways of processing them.

3. The data processing system of claim 2, wherein the application is arranged to present the analyzed data on the graphical user interface and allow the users to further manipulate the detailed data.

4. The data processing system of claim 1, wherein the vendor further comprises an encoder arranged to encode the purchase data before sending it to the server, and wherein the data processing system further comprises a decoding server arranged to decode the encoded purchase data, and associated with the vendor and the server with specified access limitations thereto.

5. The data processing system of claim 1, wherein the identification data is represented on the identification device as a barcode encoding both the identification data and a card identification, allowing the vendor to identify the use of the identification device.

6. The data processing system of claim 1, wherein the identification device comprises a communication module and the vendor comprises a transceiver, and wherein the communication module is arranged to allow sending the user identification data to the transceiver via a wireless communication link.

7. The data processing system of claim 1, wherein the graphical user interface is arranged to allow the user to act on aggregated purchase data.

8. The data processing system of claim 1, wherein the user purchase data comprises at least one of: invoices, debits, coupons, shopping lists relating to material or virtual transactions.

9. The data processing system of claim 1, wherein the user identification data comprises at least one of: a user number at the server, payment data, membership data in customer clubs, coupons.

10. A computer implemented method of aggregating purchase data comprising:
configuring an identification device associated with a user to comprise user identification data;
receiving the user identification data from the identification device during a purchase event of the user from a vendor;
generating purchase data in relation to the purchase event;
storing the purchase data on a server in association with the user identification data; and
allowing the user to access the stored purchase data via a communication link,
wherein the purchase data is aggregated on the server in association with the user identification data, and the server is configured to allow the user to aggregate purchase data in a paperless manner.

11. The computer implemented method of claim 10, wherein the user purchase data comprises at least one of: invoices, debits, coupons, shopping lists relating to material or virtual transactions.

12. The computer implemented method of claim 10, wherein the user identification data comprises at least one of: a user number at the server, payment data, membership data in customer clubs, coupons.

13. The computer implemented method of claim 10, further comprising identifying the identification device and determining a mode of data receipt.

14. The computer implemented method of claim 10, further comprising allowing the users to directly refer to details of their purchase data.

15. The computer implemented method of claim 10, further comprising analyzing the purchase data according to predefined criteria.

16. The computer implemented method of claim 10, further comprising encoding the purchase data, and storing the purchase data on a server in association with the user identification data.

17. The computer implemented method of claim 10, further comprising relating the purchase data to data in a predefined database comprising the user identification data

18. A computer program product for aggregating purchase data, the computer program product comprising a computer usable medium having computer usable program code tangibly embodied thereon, the computer usable program code comprising:
computer usable program code for receiving user identification data from an identification device during a purchase event of a user from a vendor, wherein the identification device is associated with the user and is configured to comprise the user identification data;
computer usable program code for generating purchase data in relation to the purchase event;
computer usable program code for storing the purchase data on a server in association with the user identification data; and
computer usable program code for allowing the user to access the stored purchase data via a communication link,
wherein the purchase data is aggregated on the server in association with the user identification data, and the server is configured to allow the user to aggregate purchase data in a paperless manner.

19. The computer program product for aggregating purchase data of claim 18, wherein the computer usable program code further comprises computer usable program code for allowing the user to determine the mode of data receipt.

20. The computer program product for aggregating purchase data of claim 18, wherein the computer usable program code further comprises computer usable program code for allowing users to directly refer to details of their purchase data.
